(19) United States
(12) Patent Application Publication
(10) Pub. No.: US 2015/0015688 A1
(43) Pub. Date: Jan. 15, 2015

(54) FACIAL UNLOCK MECHANISM USING LIGHT LEVEL DETERMINING MODULE

(71) Applicant: HTC Corportion, Taoyuan County (TW)

(72) Inventor: Kae-Cherng Yang, Taoyuan County (TW)

(21) Appl. No.: 13/938,203

(22) Filed: Jul. 9, 2013

(51) Int. Cl. G06K 9/00; G06F 21/32; H04N 7/18

(52) U.S. Cl. CPC G06K 9/00288; H04N 7/18; G06F 21/32
USPC 348/77

(57) ABSTRACT

An electronic device that can selectively enable a facial recognition unlock mechanism of the electronic device includes: a display screen, for displaying information to be viewed by a user; a camera, for capturing at least an image; a light level determining module, for determining ambient light levels; and a facial unlocking module, for comparing a captured image with a stored image and unlocking the electronic device when the captured image is determined to match the stored image. When the light level determining module determines that ambient light levels fall outside a predetermined range for performing a facial recognition function on a captured image, the display screen will inform the user via a display mechanism on the display screen.

### BACKGROUND OF THE INVENTION

1. Field of the Invention

The present invention relates to electronic devices which use a facial recognition technique to unlock the device, and more particularly, to electronic devices using facial recognition to unlock the device wherein the electronic device utilizes a light level determining module as a means for selectively enabling the facial recognition unlocking method or an alternative unlocking method.

2. Description of the Prior Art

Modern smart phones and other personal electronic devices often incorporate a facial recognition feature. This allows a user to capture their image on the electronic device's dedicated camera, match the image to a stored image in the database by the means of image rendering technology, and then unlock the device if there is an image match.

When the electronic device is powered on and the camera is operative, a certain amount of time will be required for the camera to perform necessary operations such as exposure. Please note that similar steps may need to be undergone when an electronic device ‘wakes up’ from a standby state. Once the image is captured, if the image does not match a stored image (i.e. an image of the owner), the electronic device will return a negative acknowledgment and another unlock method (such as typing a password) will need to be entered. This is a built in security feature of the device. When the camera cannot capture enough detail due to under/over exposure, the facial recognition cannot be performed. In this case, even if the user is the owner of the electronic device, the electronic device will still return a negative acknowledgment and a different unlock method will need to be entered.

The under/over exposure could happen for a number of reasons. The environment in which the image is captured may be too dark or too bright, such that the object in the image does not display enough detail. In these situations, it will be impossible for the camera to capture an image for which facial recognition can be performed, but the user must still wait for the camera to perform the above-mentioned exposure control, even though the electronic device will ultimately switch to another unlocking procedure. This decreases the efficiency of the device and results in an annoying and unsatisfactory user experience.

Therefore, the invention aims to provide a technique for selecting an appropriate unlock method for an electronic device.

### SUMMARY OF THE INVENTION

An electronic device that can selectively enable a facial recognition unlock mechanism of the electronic device comprises: a display screen, for displaying information to be viewed by a user; a camera, for capturing at least an image; a light level determining module, for determining ambient light levels; and a facial unlocking module, for comparing a captured image with a stored image and unlocking the electronic device when the captured image is determined to match the stored image. When the light level determining module determines that ambient light levels fall outside a predetermined range for performing a facial recognition function on a captured image, the display screen will inform the user via a display mechanism on the display screen.

A method for selectively enabling a facial recognition unlock mechanism of an electronic device comprises: utilizing a light level determining module to determine ambient light levels; when the light level determining module determines ambient light levels are within a predetermined range, capturing the image and using a facial unlocking module to compare the captured image with a stored image, and unlocking the electronic device when the captured image is determined to match the stored image; and when the light level determining module determines ambient light levels fall outside the predetermined range, activating a display mechanism on a display screen of the electronic device.

A computer programmable medium disposed in an electronic device is also disclosed, wherein the computer programmable medium performs the steps of: detecting ambient light levels with a light sensor of the electronic device; determining whether detected ambient light levels fall within a predetermined range; and when determining the ambient light levels fall within the predetermined range, capturing an image with a camera of the electronic device, and comparing the captured image with a stored image to activate a facial unlocking module for unlocking the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional smart phone illustrating location of various components of the smart phone.

FIG. 2 is a flowchart of an exemplary method for unlocking the smart phone illustrated in FIG. 1 according to the present invention.

FIG. 3 is a flowchart of an adjustment step illustrated in FIG. 2.

### DETAILED DESCRIPTION

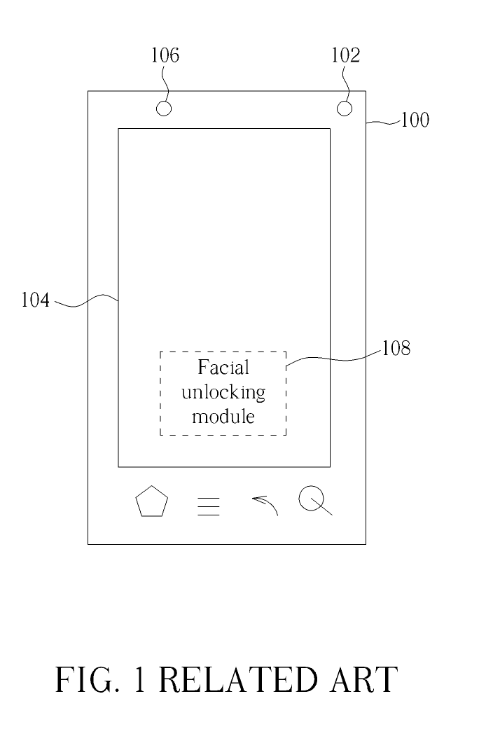

Please refer to FIG. 1, which is a diagram of a conventional smart phone 100. Please note that a smart phone is illustrated herein as an exemplary embodiment of the invention, but any personal electronic device which has a dedicated camera and light level determining module and employs a facial recognition procedure as a means for unlocking the electronic device falls within the scope of the invention. As illustrated in the diagram, the smart phone 100 includes a dedicated camera 102. The smart phone also includes a display 104, as well as a light level determining module 106. The display 104 may comprise a touch screen input. The light level determining module 106 is for determining the amount of ambient light in a certain environment which is used as a barometer for adjusting the brightness of the display 104. Shown in dashed lines (as this component is internal to the smart phone 100) is a facial unlocking module 108, which uses facial recognition software as a basis for unlocking the smart phone 100. Please note that the positioning of the elements on the smart phone 100 is merely one example; what is important is that both the light level determining module 106 and the dedicated camera 102 are front facing, i.e. facing the user.

As mentioned in the background, when a smart phone is powered on, the dedicated camera 102 of the smart phone 100 requires a certain amount of time to perform necessary exposure control. If a level of ambient light falls outside a threshold range—for example, ambient light is too bright so that ambient light levels are greater than an upper threshold of the threshold range, or ambient light is too dark so that ambient light levels fall below a lower threshold of the threshold range—then the electronic device 100 will be unable to successfully perform facial recognition on the captured image, the facial unlocking module 108 cannot be operated, and an alternative unlocking method will need to be entered. The efficiency and user experience of the device is compromised by this process. The exemplary embodiments detailed herein therefore provide a method which can quickly determine whether or not the facial recognition can be successfully performed on a captured image.

As illustrated in FIG. 1, the smart phone 100 includes a light level determining module 106 for determining a level of ambient light. The light level determining module 106 will be operable far earlier than the dedicated camera 102 after the smart phone 100 is powered on or woken up; the invention can therefore use the light level determining module 106 to determine whether ambient light levels fall within a range which allows facial recognition to be performed on a captured image and the facial unlocking module 108 to be operated. Please note that power-on means a state wherein the smart phone 100 is powered-up or booted-up from a shutdown state, whereas wake-up means that normal operation of the smart phone 100 resumes from a sleep or hibernate state. If the ambient light levels fall outside the range, the smart phone 100 can inform the user in some way, automatically adjust parameters of the smart phone 100 to enable the facial unlocking module 108, or directly enter the alternative unlock method, such that the user's time is not wasted. Please note that the range of ambient light levels in which facial recognition can be performed can be determined in advance, in accordance with a specification of the facial recognition technology used by the smart phone 100.

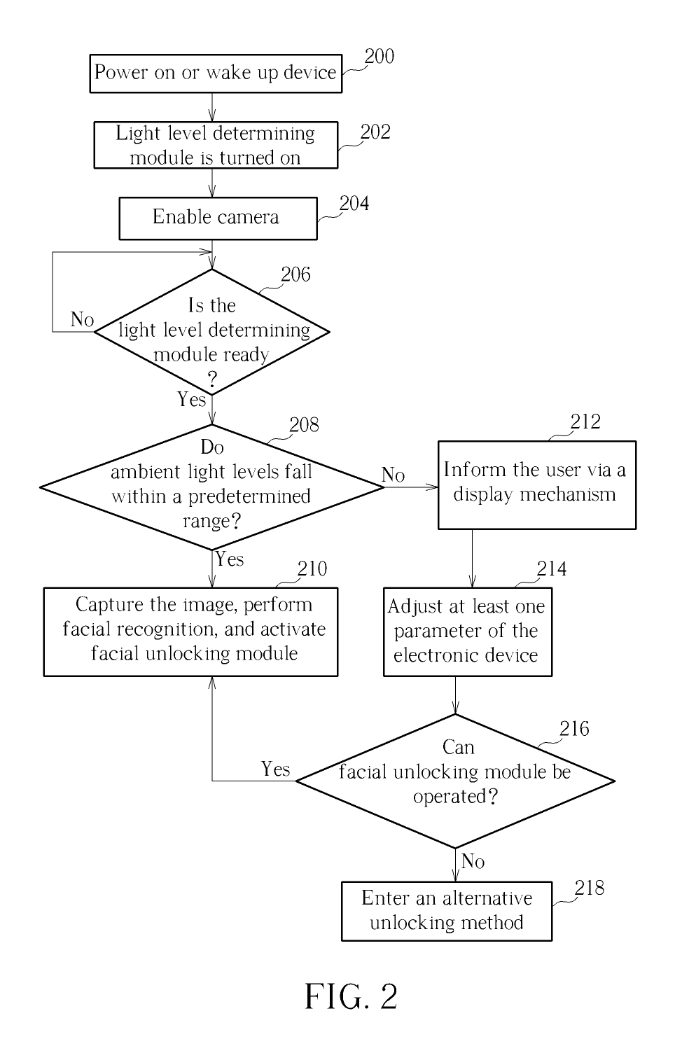

An exemplary method is illustrated in FIG. 2. The steps of the method are detailed as follows:

Step 200: Power on or wake up the smart phone;

Step 202: Light level determining module is turned on;

Step 204: Enable the camera;

Step 206: Is the light level determining module ready? If yes, go to Step 208; if no, return to Step 206;

Step 208: According to the light level determining module, do the ambient light levels fall within a predetermined range? If yes, go to Step 210; if no, go to Step 212;

Step 210: Capture the image, perform facial recognition, and activate the facial unlocking module;

Step 212: Inform the user via a display mechanism that ambient light levels fall outside the predetermined range;

Step 214: Adjust at least one parameter of the smart phone.

Step 216: Can the facial unlocking module be operated after adjustment? If yes, go to Step 210; if no, go to Step 218;

Step 218: Enter an alternative unlocking method.

In the flowchart, when it is determined in Step 208 that the ambient light levels fall outside the predetermined range, the smart phone 100 first informs the user via a display mechanism: for example, an error message on the screen, or a flashing light (Step 212). The smart phone 100 then enters an adjustment method (step 214) wherein it can adjust a plurality of parameters of the smart phone 100. Please note that one, some or all of the parameters can be adjusted, and parameters can be adjusted separately (i.e. one by one), or at the same time. If it is determined that the facial unlocking module can be operated after the adjustment, the flow returns to Step 210 and the image is captured. If it is determined in Step 216 that the facial unlocking module still cannot be operated after adjustment of the parameters, the smart phone 100 will enter an alternative unlocking method (Step 218). Please note that certain modifications can be made to the above flowchart. For example, it is possible for the smart phone 100 to directly enter the alternative unlocking method without adjusting any parameters. Determination as to which modification is implemented can be made according to requirements.

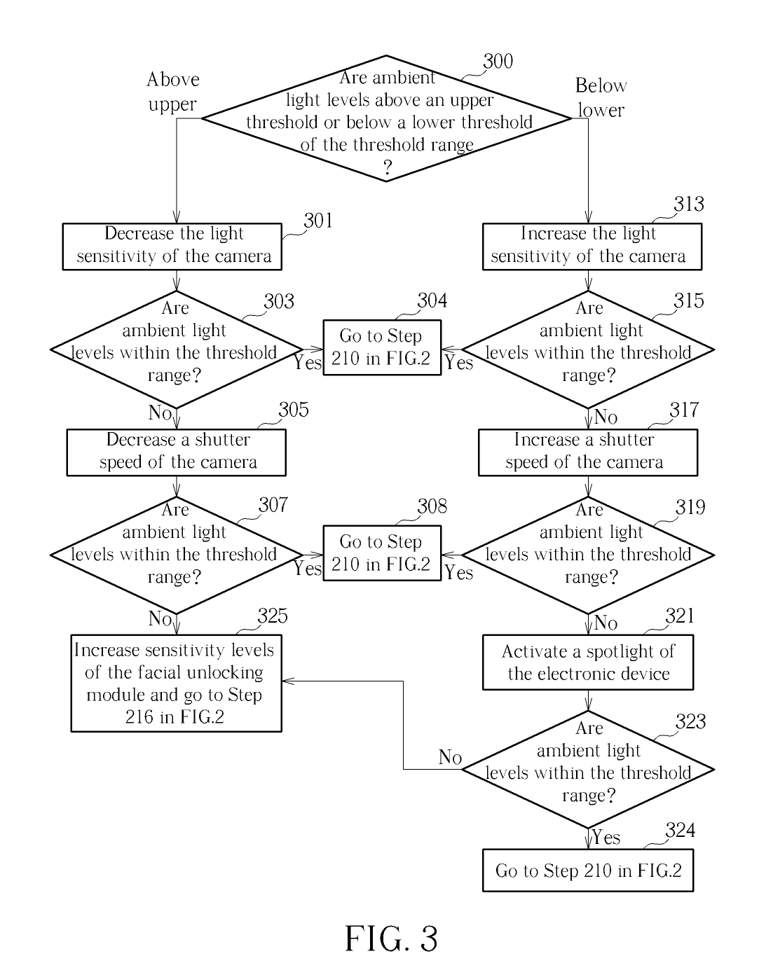

Please refer to FIG. 3, which details an adjustment method of Step 214. This is a preferred embodiment of the adjustment method, wherein parameters are adjusted in turn. As detailed above, it is also possible for all parameters to be adjusted at the same time, or for the order in which parameters are adjusted to be changed. As one skilled in the art would be able to make the necessary modifications after reading the disclosure, further detail is not provided.

Step 300: Are ambient light levels above an upper threshold or below a lower threshold of the threshold range? If they are above an upper threshold, go to Step 301; if they are below a lower threshold, go to Step 313;

Step 301: Decrease the light sensitivity of the camera;

Step 303: Are ambient light levels within the threshold range? If yes, go to Step 304; if no, go to Step 305;

Step 304: Go to Step 210 in FIG. 2;

Step 305: Decrease a shutter speed of the camera;

Step 307: Are ambient light levels within the threshold range? If yes, go to Step 308; if no, go to Step 325;

Step 308: Go to Step 210 in FIG. 2;

Step 313: Increase the light sensitivity of the camera;

Step 315: Are ambient light levels within the threshold range? If yes, go to Step 304; if no, go to Step 317;

Step 317: Increase a shutter speed of the camera; Step 319: Are ambient light levels within the threshold range? If yes, go to Step 308; if no, go to Step 321;

Step 321: Activate a spotlight of the electronic device;

Step 323: Are ambient light levels within the threshold range? If yes, go to Step 324; if no, go to Step 325;

Step 324: Go to Step 210 in FIG. 2;

Step 325: Increase sensitivity levels of the facial unlocking module and go to Step 216 in FIG. 2.

Initially, it is determined whether the ambient light levels are above an upper threshold or below a lower threshold of the threshold range (Step 300). According to the determination, light sensitivity of the camera 104 will either be lowered (Step 301) or increased (Step 313). Respective determinations (steps 303 and 315) are then made as to whether ambient light levels fall within the threshold or not. If they fall within the threshold, the flow will proceed to Step 304, and then to Step 210 in FIG. 2, wherein the image will be captured and the facial unlocking module will be activated.

If ambient light levels are still outside the threshold range, the flow proceeds, respectively, to Step 305 where shutter speed of the camera will be decreased, or to Step 317 where shutter speed of the camera will be increased. Further respective determinations (steps 307 and 319) are again made as to whether ambient light levels fall within the threshold or not. If they fall within the threshold, the flow will proceed to Step 308, and then to Step 210 in FIG. 2, wherein the image will be captured and the facial unlocking module will be activated.

If it is determined in Step 307 that ambient light levels are outside the threshold, the flow will proceed to Step 325, where sensitivity levels of the facial unlocking module are increased. The flow then returns to Step 216 in FIG. 2, where it is determined whether the facial unlocking module can be operated.

If it is determined in Step 319 that ambient light levels are outside the threshold, the flow will proceed to Step 321, wherein a spotlight of the electronic device will be activated. In Step 323 it is determined whether ambient light levels fall within the threshold or not. If they fall within the threshold, the flow will proceed to Step 324, and then to Step 210 in FIG. 2, wherein the image will be captured and the facial unlocking module will be activated. If it is determined in Step 323 that ambient light levels are outside the threshold, the flow will proceed to Step 325, where sensitivity levels of the facial unlocking module are increased. The flow then returns to Step 216 in FIG. 2, where it is determined whether the facial unlocking module can be activated.

It is also possible to reverse the order of Step 204, Step 206 and Step 208, such that the camera 102 is only turned on when the light sensor 106 verifies ambient light levels fall outside the predetermined range for performing facial recognition. The order shown in FIG. 2 is the preferred method, however, as the camera 102 will require some time before it becomes operable. It is also possible that the light level determining module 106 which is used is the light sensor of the dedicated camera 102.

As the present invention can quickly determine whether or not ambient light levels fall within a particular required range for performing facial recognition so that a facial unlocking module cannot be operated, an electronic device can quickly determine that an alternative unlock method needs to be entered. If the ambient light levels fall outside the particular range, the electronic device can also adjust the light sensitivity and/or the shutter speed of the camera, activate a spotlight for increasing the ambient light in the same environment, increase the sensitivity of the facial unlocking module such that the image can still be recognized and the facial unlocking module can be activated, or select an alternative unlock method. If the electronic device directly enters the alternative unlock method, the user can still quickly unlock and operate the electronic device. Therefore, both efficiency and user satisfaction are increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device that can selectively enable a facial recognition unlock mechanism of the electronic device, comprising:
a camera, for capturing at least an image;
a light sensor, for detecting ambient light levels;
a light level determining module, for determining whether ambient light levels fall within a predetermined range; and
a facial unlocking module, configured to perform a facial unlock function;
wherein when the light level determining module determines that ambient light levels fall within a predetermined range, the camera will capture an image and the facial unlocking module will perform the facial unlock function by comparing the captured image with a stored image to unlock the electronic device.

2. The electronic device of claim 1, further comprising:
a display screen;
wherein when the light level determining module determines the detected ambient light levels fall outside the predetermined range, the display screen displays an error message.

3. The electronic device of claim 2, wherein the electronic device will further adjust at least a parameter of the electronic device.

4. The electronic device of claim 3, wherein the electronic device adjusts at least a light sensitivity of the camera.

5. The electronic device of claim 3, wherein the electronic device at least adjusts sensitivity levels of the facial unlocking module.

6. The electronic device of claim 1, wherein the electronic device enters an alternative unlock mechanism when ambient light levels fall outside the predetermined range.

7. The electronic device of claim 6, wherein the alternative unlock mechanism comprises at least one of a password entry, a gesture entry, a signature entry, finger print recognition, and voice recognition.

8. The electronic device of claim 1, wherein a spotlight of the electronic device is activated when the light level determining module determines the detected ambient light levels fall below a lower threshold of the predetermined range.

9. The electronic device of claim 1, wherein:
the light sensor is activated when the electronic device is powered on or woken up; and
the camera is activated when the light level determining module determines the detected ambient light levels fall within the predetermined range.

10. The electronic device of claim 1, wherein the camera and the light sensor are activated when the electronic device is powered on or waked up.

11. The electronic device of claim 1, wherein the camera is activated earlier than the light sensor.

12. A method for selectively enabling a facial unlocking function of an electronic device, the method comprising:
detecting ambient light levels with a light sensor of the electronic device;
determining whether detected ambient light levels fall within a predetermined range; and
when determining the ambient light levels fall within the predetermined range, capturing an image with a camera of the electronic device, and comparing the captured image with a stored image to activate a facial unlocking module for unlocking the electronic device.

13. The method of claim 12, further comprising:
displaying an error message on a display screen of the electronic device when determining the ambient light levels fall outside the predetermined range.

14. The method of claim 13, wherein the electronic device will further adjust at least a parameter of the electronic device.

15. The method of claim 14, wherein the electronic device adjusts at least a light sensitivity of the camera.

16. The method of claim 14, wherein the electronic device at least adjusts sensitivity levels of the facial unlocking module.

17. The method of claim 12, wherein the electronic device further enters an alternative unlock mechanism.

18. The method of claim 17, wherein the alternative unlock mechanism comprises at least one of a password entry, a gesture entry, a signature entry, fingerprint recognition, and voice recognition.

19. The method of claim 12, further comprising:
activating a spotlight of the electronic device when determining the ambient light levels fall below a lower threshold of the predetermined range.

20. The method of claim 12, further comprising:
activating the light sensor when detecting the electronic device is powered on or woken up; and
activating the camera when determining the ambient light levels fall within the predetermined range.

21. The method of claim 12, further comprising:
activating the camera and the light sensor when detecting the electronic device is powered on or woken up.

22. The method of claim 12, wherein the camera is activated earlier than the light sensor.

23. A computer programmable medium disposed in an electronic device for performing the steps of:
detecting ambient light levels with a light sensor of the electronic device;
determining whether detected ambient light levels fall within a predetermined range; and
when determining the ambient light levels fall within the predetermined range, capturing an image with a camera of the electronic device, and comparing the captured image with a stored image to activate a facial unlocking module for unlocking the electronic device.

24. The computer programmable medium of claim 23, further performing the steps of:
displaying an error message on a display screen of the electronic device when determining the ambient light levels fall outside the predetermined range.

25. The computer programmable medium of claim 24, wherein the electronic device will further adjust at least a parameter of the electronic device.

26. The computer programmable medium of claim 25, wherein the electronic device adjusts at least a light sensitivity of the camera.

27. The computer programmable medium of claim 25, wherein the electronic device at least adjusts sensitivity levels of the facial unlocking module.

28. The computer programmable medium of claim 23, wherein the electronic device further enters an alternative unlock mechanism.

29. The computer programmable medium of claim 28, wherein the alternative unlock mechanism comprises at least one of a password entry, a gesture entry, a signature entry, finger print recognition, and voice recognition.

30. The computer programmable medium of claim 23, further performing the steps of:
activating a spotlight of the electronic device when determining the ambient light levels fall below a lower threshold of the predetermined range.

31. The computer programmable medium of claim 23, further performing the steps of:
activating the light sensor when detecting the electronic device is powered on or woken up; and
activating the camera when determining the ambient light levels fall within the predetermined range.

32. The computer programmable medium of claim 23, further performing the steps of:
activating the camera and the light sensor when detecting the electronic device is powered on or woken up.

33. The computer programmable medium of claim 23, wherein the camera is activated earlier than the light sensor.
